(19) United States
(12) Patent Application Publication
(10) Pub. No.: US 2017/0013046 A1
(43) Pub. Date: Jan. 12, 2017

(54) DATA-CENTRIC DATA STORAGE

(71) Applicant: PRIMARYDATA, INC., Los Altos, CA (US)

(72) Inventor: David Flynn, Salt Lake City, UT (US)

(21) Appl. No.: 15/276,075

(22) Filed: Sep. 26, 2016

Related U.S. Application Data
(63) Continuation of application No. 14/946,770, filed on Nov. 19, 2015, now abandoned.
(60) Provisional application No. 62/081,555, filed on Nov. 18, 2014.

(51) Int. Cl. H04L 29/08; H04L 29/06; G06F 17/30

(52) U.S. Cl. CPC H04L 67/06; G06F 17/30312; H04L 67/42; H04L 61/1582

(57) ABSTRACT

A data-centric storage system is described herein that changes the focus to what data an organization needs to store, and relieves IT personnel of thinking about how storage is configured to serve that data. For any given organization, a set of application data needs and a set of storage capabilities can be. From these two, a figure of merit can be applied to automatically determine an association between each application's data needs and the available storage devices, to map the data to one or more storage devices. In addition, recommendations can be automatically generated to inform IT personnel where the greatest impact from additional storage nodes can be achieved. Thus, the system allows IT personnel to focus on data and the needs of their organization, and to rely on the system to take on the burden of meeting those needs with particular storage devices and configuration of those storage devices.

### CROSS-REFERENCE TO RELATED APPLICATIONS

The present application is a continuation of U.S. patent application Ser. No. 14/946,770 (Attorney Docket No. PDATA01202) entitled “DATA-CENTRIC DATA STORAGE,” and filed on 2015 Nov. 19, which claims the benefit of U.S. Provisional Patent Application No. 62/081,555 (Attorney Docket No. PDATA01201) entitled “DATA-CENTRIC DATA STORAGE,” and filed on 2014 Nov. 18, each of which is hereby incorporated by reference.

### BACKGROUND

Computing systems have extensive needs for storing data. Data storage over the years has evolved from non-networked computers with local, direct-attached hard drives and other storage (e.g., tape drives, floppy disks CD-ROMs, and so forth), to networked computers with access to a vast variety of types of data storage. File servers provide files in a network environment. These servers started out as general-purpose computers providing network-based access to their own local, direct-attached storage (DAS). Over time, they evolved to include sophisticated storage devices operating under the control of the file server, which still provided access to the storage arrays to clients. This type of storage typically improved by including faster drives (e.g., higher revolutions per minute (RPM) rotating media, solid-state disk drives (SSD), and so forth), faster connection to the drives (e.g., SCSI, FibreChannel, etc.), features such as redundant array of inexpensive disks (RAID) to improve latency and throughput, and other optimizations. Over time, the computing power and resource usage of the general-purpose computer itself became a limiting factor when acting as a file server, and appliances built from the ground up for providing storage were introduced, referred to as network-attached storage (NAS).

NAS devices may include any of the optimizations applied to file servers, as well as customization of the operating system, software applications, memory, network hardware, specialized caching, and other computing resources of the server itself. NAS devices typically use file-based protocols, such as NFS (common for UNIX), SMB/CIFS (common for Windows), AFP (common for Mac), and NCP (common for NetWare) for communicating with clients who wish to access data. In contrast to NAS, storage area networks (SANs), typically provide block-based (i.e., lower-level than file-based) access to a series of logical units (LUNs) over a fast data connection, such as FibreChannel, iSCSI, ATA over Ethernet (AoE) and HyperSCSI. SAN can provide a more direct connection between central processing units (CPUs) and the storage devices without going through a network, but also are limited in how they can be shared by multiple clients because of the lack of a well-defined interface like that provided over a network with file-based access. Typically, a single client system has authority over and accesses a particular LUN at a time.

Each of these technologies is directed to providing ever-faster access to data. A second goal often layered on top of each of these technologies is providing data reliability. Reliability may refer to backup techniques, replication, error correction, disaster recovery, snapshotting, and other features. For NAS devices, the provision of a uniform interface to clients at the network layer means that the configuration and layout of the storage behind the network access protocols provided to the client is opaque to the client. This means that NAS devices can employ techniques such as maintaining redundant copies, using various RAID levels, or other techniques to maintain client access to data even in the face of various types of hardware and other failures. For SAN devices, techniques such as block virtualization are applied to separate logical storage presented to clients from the physical storage that backs the logical storage, allowing for many of the same techniques applied to NAS for disaster recovery to work for these devices as well.

To provide ever-faster access to data, and to serve more clients in larger and larger organizations, companies have traditionally applied a “scale up” approach. Scale up refers to increasing the storage system's ability to meet increasing demands by adding storage or upgrading other pieces of the system (e.g., computing power or bandwidth). Often, there are hard limits of just how far these factors can go. For example, a particular computing system can only include the best processor currently on the market, or as many such processors as current computing technology can support. Bandwidth can also be a factor, as networks have limits to how fast they can operate with each generation of technology. When the storage system's capacity is bottlenecked on one of these elements, a company is often faced with waiting for better hardware and upgrading its entire storage infrastructure to get better performance.

To overcome this problem, “scale out” storage was developed. In scale out systems, storage is comprised of a series of nodes each having its own compute power, bandwidth, and storage capacity. New demands for storage are met by buying more nodes, and in doing so, the aggregate compute power, bandwidth, and storage capacity increases together. Old nodes are not made obsolete by the addition of new nodes. Rather, they are augmented by the additional resource capacity. Instead of the overbuying that is common with scale up solutions to prevent hitting the inevitable limits, scale out allows purchasing the right amount of capability for the current storage needs, and expanding that capacity as storage needs change.

Regardless of which of these technologies an organization chooses, information technology (IT) personnel of the organization are tasked with a heavy amount of storage-centric thinking. Storage-centric thinking means that the focus is on the types and specific instances of data storage devices, rather than the types and instances of data. IT personnel often spend time determining what the application needs of various departments of the organization are, and then commence buying storage systems to service each of these application needs. There is often a one-to-one mapping between particular application uses and particular storage systems. For example, the IT personnel may decide that system X will include Y servers and will serve all of the loads associated with the organization's email system. Another system will serve the needs of a particular database (e.g., used by the sales team). Other systems may serve other needs, such as dedicated file servers for engineering departments, marketing, or other parts of the organization.

Because particular applications have unique demands, the IT personnel are then tasked with configuring the storage systems in a manner that is appropriate for the demands. For example, a storage system that will hold financial data for a bank may be mission-critical in a manner that no data can be lost, so heavy data preservation schemes may be applied (e.g., redundancy, backups, and so forth). For an application such as a database that creates numerous temporary files to which fast access is needed, the speed of the storage may be prioritized over preventing data loss. The IT personnel will build this system differently to meet these needs. In the end, the IT personnel are left with a vast thicket of storage systems and applications to manage and with domain-specific knowledge about how each server is used and configured, and thus how particular data maps to particular storage devices. This is termed a storage-centric view as the focus is on the storage devices, including how the storage devices are configured and which storage devices are targeted to which application loads.

### BRIEF DESCRIPTION OF THE DRAWINGS

FIG. 1 is a block diagram that illustrates components of the data-centric storage system, in one embodiment.

FIG. 2 shows an alternative view of FIG. 1 with major components of the system placed on the machines where they reside, in one embodiment.

FIG. 3 is a flow diagram that illustrates processing of the data-centric storage system to handle a client application request to access data managed by the system from the perspective of a data hypervisor on the client, in one embodiment.

FIG. 4 is a flow diagram that illustrates processing of the data-centric storage system to automatically configure data storage resources when the system is introduced in a new organization, in one embodiment.

FIG. 5 is a block diagram that illustrates subcomponents of the data-movement component shown in FIG. 1, in one embodiment.

FIG. 6 is a flow diagram that illustrates processing of the data-centric storage system to handle a request to move data when a data access session begins, in one embodiment.

FIG. 7 is a flow diagram that illustrates processing of the data-centric storage system to handle a request to move data that is already being accessed, in one embodiment.

FIG. 8 is a block diagram that illustrates subcomponents for implementing multi-mode DAS, in one embodiment.

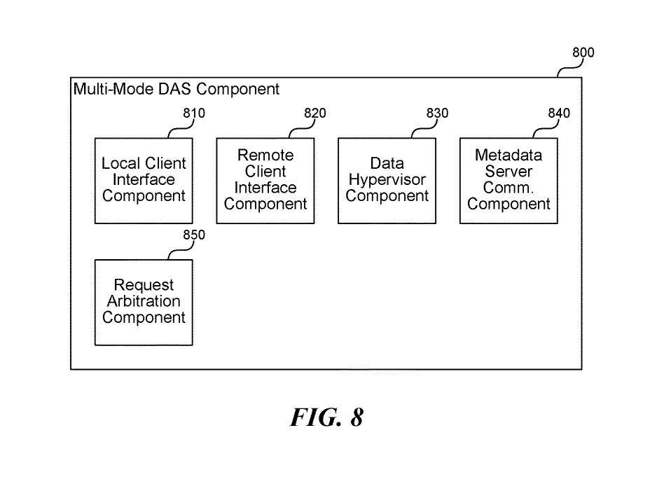

FIG. 9 is a flow diagram that illustrates processing of the data-centric storage system to export a multi-mode DAS, in one embodiment.

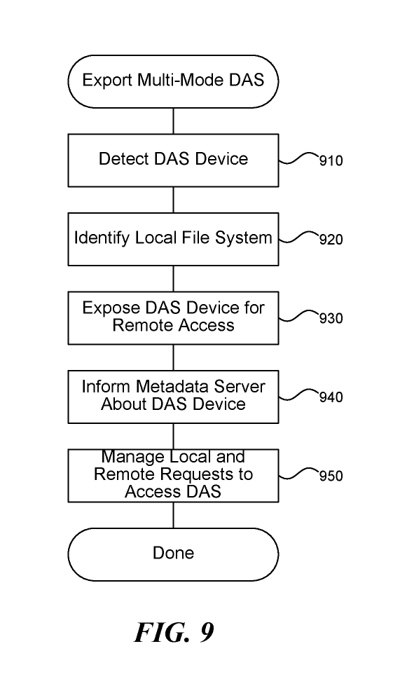

FIG. 10 is a flow diagram that illustrates processing of the data-centric storage system to re-route remote requests to a local DAS, in one embodiment.

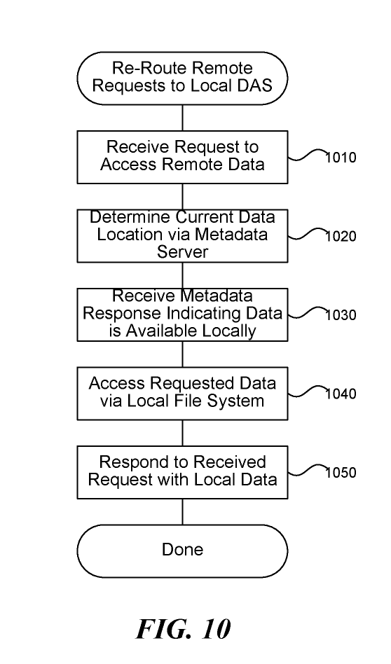

### DETAILED DESCRIPTION

A data-centric storage system is described herein that changes the focus to what data that an organization needs to store, and relieves IT personnel of thinking about how storage devices are configured to serve that data. For any given organization, a set of application data needs can be determined and a set of storage capabilities can be automatically calculated. From these two, a figure of merit can be applied to automatically determine an association between each application's data needs and the available storage devices. In addition, recommendations can be automatically generated to inform IT personnel where the greatest impact from additional storage nodes can be achieved. Another way of thinking of the data-centric nature of the system is as a data virtualization layer. Whereas traditional virtualization technology focuses on virtualizing the processing resources of a computing system, such that computing instances need not be aware of the actual computing hardware on which they are running, data virtualization virtualizes the data storage devices, such that data need not be aware and IT personnel can be less focused upon the data's placement on particular data storage devices.

Rather than focusing on storage configuration, the primary input to such a system from IT personnel is a specification of the various data needs of the organization. For example, the organization may have various classes of data that can be specified as requirements to the system. These classes of data may include data that must be kept confidential (where security is a primary concern), data that requires very low latency, data that requires high availability to a number of clients, data that is primarily of a nature that only one client will access it, data that is very important and cannot be lost (where disaster recovery is a primary concern), and so forth. By mapping out all of the various data needs, the IT personnel can provide the system with a data-centric view of the organization's needs. In some embodiments, the system may even be able to generate this type of input automatically. For example, applications may be designed to provide hints about their storage needs, so that the system can gather requests from the various applications used by an organization to complete a picture of that organization's needs for data storage.

On the storage side, the system can automatically determine an organization's storage needs from the received data needs. The system may be used at a variety of stages in an organization's storage lifecycle. In some cases, the system may be used for planning purposes before any storage devices have been purchased. In such cases, the system acts as an information tool to provide IT personnel with a recommendation of what storage devices should be purchased to meet the organization's data needs. In other cases, a mature organization may already have an extensive installation of data storage devices, and may install the data-centric storage system to take over management of these devices. In these cases, the system can automatically inventory the available storage devices of an organization, and determine the existing configuration. The system can then use this information to: a) provide recommendations or automatic reconfiguration to more optimally utilize the existing storage devices, b) suggest purchases of additional storage devices that would improve application performance, or c) some combination of these two. In the course of this automated behavior, the system is performing what is today a burdensome and manual IT process. In addition, because of the automation of this task, it can be re-performed frequently to continually improve an organization's data storage situation. Thus, the data-centric storage system allows IT personnel to focus on data and the needs of their organization, and rely on the system to take on the burden of meeting those needs with particular storage devices and configuration of those storage devices.

One element that is made much more flexible by the data-centric storage system is where data lives, or more specifically the mapping of any particular unit of application data to one or more data storage devices. Unlike in the current model where IT personnel typically set particular application data to be stored on particular servers where it stays throughout its lifetime (or at least is moved very deliberately and intentionally in a manual decision-making process), the data-centric storage system can move the location of data frequently and for a variety of purposes. For example, data that is primarily read-only that is used by many clients can be moved in multiple copies to the clients themselves, where the clients can access the data with all of the speed of direct-attached storage. Similarly, data that is typically only used by one particular client (e.g., one-to-one data such as user profiles) can be moved or copied to that client where it can be accessed without any network latency or other delays. Data that is stored one data storage server but is accessed in a manner that would make it faster to access if it were on another data storage server can be automatically moved by the system to permit better utilization of the available storage devices. All of this type of movement can occur automatically without the involvement of IT personnel.

With the data-centric storage system, data can literally be anywhere within an organization. Because of this, there is a need to provide a client application with a way to find the data it needs at the time it wants to use it. Unlike the storage-centric view of data storage, where an application might know to always find its data at a particular server's address (e.g., via a server name and share path), in the data-centric view data is mobile and may be somewhere other than where it was originally or where it was the last time it was accessed. One feature provided by the system is the notion of a metadata server that acts as a kind of directory for finding data. A client wanting to access data first asks the directory where the data is, and then goes to that location to access the data. In the course of this exchange, the system may actually move the data to more optimally match the client's expressed needs with the available storage resources (e.g., if the system determines that server A where the data is currently located is currently satisfying a high quantity of demands, the system may move the data to server B, which is more underutilized). The system can then return the data's new location to the client, which can access the data at that location directly.

NFS version 4.1 allows storage requests that would previously have passed through a storage server to access data striped across one or more storage devices, to instead have a brief conversation with the storage server (which is re-termed a metadata server) and then to communicate directly with the storage devices. In situations where the storage server manages multiple storage devices, this permits much higher performance by allowing parallel communication between the client and multiple storage devices. For this reason, this extension to NFS is often referred to as parallel NFS (pNFS). pNFS shifts responsibility for managing file access from the NFS server to a combination of the server and the client. pNFS only envisions that an NFS server with multiple attached storage devices can provide alternative direct access to those storage devices from the client without going through the storage server. Generally, the storage server will provide both legacy (i.e., non-parallel, pre-NFS version 4.1) access to the storage devices through storage server, as well as the newer, parallel access directly to the storage devices. While pNFS improves performance, it maintains the storage-centric view of data storage systems.

The data-centric storage system can leverage pNFS to provide the type of directory lookup described above. The system's metadata server may act as an NFS version 4.1 metadata server, but may also have capabilities beyond those provided by an NFS version 4.1 metadata server. Thus, the system's metadata server is not synonymous with NFS version 4.1's metadata server, though it may be related. In addition, the system can be implemented using storage protocols other than NFS version 4.1, so the system's metadata server exists at a broader conceptual scope than that of an NFS version 4.1 metadata server. However, NFS version 4.1 provides one type of implementation that separates metadata access from data access, a capability that is used by the data-centric storage system.

Although NFS version 4.1 primarily envisions that a metadata server will simply provide a way to directly access storage devices closely associated with the metadata server, there is no reason that such a metadata server cannot refer client requests to any data storage device throughout an organization. Implementation of the metadata server in NFS version 4.1 is left open, and can include the kind of directory lookup capability described herein. Other protocols may contain similar support for the addition of this type of capability. In some embodiments, the data-centric storage system may employ a proprietary protocol to provide this and other capabilities. However, by leveraging an industry standard storage protocol, the system can provide compatibility with a broad range of client computing systems without necessarily needing to modify each client to be able to benefit from the features described herein.

Other network file system protocols do not currently separate metadata requests from data access requests, and do not provide the kind of directory ability for finding files at any location described above. Popular protocols are SMB/CIFS used on Windows systems, and AFP used on Apple Macintosh systems. SMB/CIFS is now in its third major revision, which adds numerous performance improvements, but does not include separation of metadata from data. However, it is foreseeable that these protocols may be extended with abilities similar to NFS version 4.1 in the future, and thus the system described herein is not limited to any particular protocol for performing the actions described herein. Moreover, it is also possible to implement the data-centric storage system over a proprietary protocol different from all of those described so far. While there is some advantage to helping standards to evolve to include advanced features needed by the system, performance or other goals not achievable through existing protocols may motivate a particular implementation to take a proprietary route.

Data placement refers to the set of methods used to determine where data will be stored at any given time by the system. In a system where data can be located anywhere, data placement determines a finite location or locations in which to store data. Data placement methods may run when new data is introduced to the system (e.g., by an application), any time data is accessed, when available storage devices of the system change, over time when data becomes stale (less frequently accessed) or hotter (more frequently accessed), or any other event that may affect the optimal placement of data throughout the system. Data placement methods of the system attempt to simultaneously satisfy a number of goals of the client applications and the data storage devices. An optimal data placement will give the client application fast and reliable access to its data while providing optimal use of the available storage devices managed by the system.

There are a variety of ways in which applications can express their data storage needs to the system. An application author can provide a specification of how the application uses data. This data specification may be automatically loadable into the system or may be manually entered by an administrator. Alternatively or additionally, an administrator may determine the application's data needs and provide a specification of these needs to the system. As another alternative, the application may automatically specify its needs through various techniques. For example, in some embodiments, applications specify attributes in the paths used to open files that include information about the application's data needs. For example, much like a hypertext transport protocol (HTTP) uniform resource locator (URL) can contain a query string after the server and virtual directory that specifies various options for viewing a web page, the path used to access a file can also contain attributes that specify the applications needs with respect to data.

These needs may include things like a minimum latency, amount of available storage capacity, reliability level, that the file is temporary, or any other expression of the application's data access needs. The system receives the path along with any specification of data access needs when a file is opened or created, and can use these as input to the data placement methods. The system may also store received data access needs along with the file or separately as metadata that can be used by the system later as the system considers new placements of data. The system may also store its own information along with data, such as historical patterns of access, or other knowledge observed by the system that affect how the data is optimally placed.

The other side of application data needs is the concept of data storage capabilities that exist within a particular organization. Data storage capabilities may be gathered by querying various data storage hardware within an organization, and can be automated to the extent this information is accessible programmatically via the network. For example, the information that a particular data storage device is using mirroring lets the system know that any data placed there will automatically have a redundant copy created, which may be useful for disaster recovery. Data storage devices may have numerous capabilities provided by the hardware used, software configuration, storage configuration, locality to various other resources, and so forth. For example, a data store that is closer in the network topology to a particular client may have the capability of low latency from the perspective of that client, and may thus be a good choice for storing data to which the client needs low latency access. Capabilities may also have a time-based component. For example, a data storage device that has planned maintenance in an hour may be a poorer choice for storing data in the next hour or two than one expected to have solid uptime over the next week.

The data placement described above then becomes a function of matching all of the known application data needs with the known set of data storage capabilities to determine an optimal (or at least acceptable) placement of data that satisfies the global needs of any particular installation of the system. Data placement may also be configured to consider future purchases that would allow for a more satisfactory placement of data. For example, if any particular resource is constrained such that various application data is competing for the same type of data storage, the system can be configured to suggest to IT personnel where the addition of new data storage devices in the system would achieve the greatest impact to meeting the application data needs.

Data movement occurs when the data placement methods determine that data is not currently located at an acceptable location. Data movement is any change in the placement of data. Data may not be moved so much as copied, such as in the case of creating a local cache of data for faster access or a redundant copy for reliability. The system may move data at any time, e.g., periodically or as requests are received. In some embodiments, the system may receive input from the application describing characteristics of the application's needs with respect to data (e.g., “I want to open file X and I need low latency”). Data may also have characteristics stored on it that describe needs related to the data that the system may take into account when deciding whether and where to move data. Data movement may occur when data is requested, to move the data to a location that suits the needs of the requesting application and any requirements of the data itself. Data movement may also periodically occur due to background processes run by the system, based on scheduled maintenance or failures of data hardware, and for other reasons.

Data movement may include specialized methods for moving data while data is being accessed. For example, the system may determine that a file or files being used by an application need to move, but may want to provide uninterrupted access to the data to the application while the data is moved. The system can use techniques such as byte range locking to lock particular ranges of a file, move that portion of the files data, and then unlock the data at the new location for continued access by the application. Protocols such as NFS version 4.1 provide mechanisms for informing a client that access to data has changed, and the system can use such mechanisms to inform a client accessing data that the data has moved to a new location.

The data-centric storage system includes various facilities for providing information to IT personnel about the state of the system and what changes may be needed to the system in the form of reports that can be automatically generated. For example, the system may include a current configuration report that will inform IT personnel of the data storage locations to which all currently stored data is mapped, including reasoning that shows why the system chose to place the data there. As previously described, another type of report may show IT personnel where the purchase and introduction of new data storage hardware to the system could improve the system's ability to satisfy application data needs. Another type of report may suggest configuration changes to existing data storage hardware that would allow that hardware to be more fully utilized to realize the system's goals. In some cases, the system may even suggest data storage devices that are not providing much useful storage and could be sold or replaced with devices that are more suitable.

Another capability that can be provided by a data-centric storage system is direct attached storage (DAS) that is addressable through a local file system and by peers via a remote file system, such as NFS. Once data can live anywhere, every hard drive or other storage device in an organization becomes a possible target for storing data, and can be considered by the data placement methods on its own merit. For some types of files, storing them locally to an application even when the application requests remote storage, or storing them on a nearby peer rather than a farther away (and thus higher latency) server may provide beneficial performance or other advantages. In this model, the same storage device is exported two ways, and the system manages the details, such as any conflict between local client access and remote requests. Local DAS can also be used as a kind of cache, where data frequently accessed by a client is mirrored or copied as needed to the client's fast DAS device. This can dramatically improve client application performance, all automatically maintained and managed by the data-centric storage system.

Another concept introduced by the data-centric storage system is that of a data portal. A data portal is a server or software running on a server (that may have other functions as well) that provides compatible access to the system for legacy clients and/or legacy storage devices. The changes introduced by the system are substantial enough that they may preclude direct access by older clients (e.g., SMB2, NFS2, NFS3, and so forth), or they may be difficult to reconcile with certain storage devices. For this reason, the system introduces data portals as a compatibility layer to translate between what the legacy devices and protocols expect, and the features provided by the data-centric storage system. Thus, the system may direct legacy client requests or requests to store data to a legacy data storage device to a data portal, and the data portal may translate the request into a format that the newer data-centric storage system is designed to handle. This translation may occur on the request and response end of the communication, so that the data portal accepts the type of requests made by legacy clients and data storage devices, and provides the types of responses expected by those clients and devices. The data portal may also become involved in data movement operations, to move data between legacy and non-legacy data storage devices.

There are various logical components that operate in a data storage system like the data-centric storage system, including an application, storage, system logic, and metadata. The application has a data-centric view of the storage world, not necessarily knowing where or how data is stored. The application knows that it wants to access particular data and may have certain requirements for accessing that data, similar to Quality of Service (QoS) in networking, as well as other types of requirements. The application is managed by an application administrator and/or author. The storage itself is comprised of data stores, potentially arranged in tiers or placed into other favorable arrangements. Storage is managed by a storage administrator.

The system provides a logic layer conceptually (although not necessarily physically) between the application and the storage. This logic layer includes metadata (such as for parallel NFS as well as custom metadata for the system), software routines (such as for data placement, data movement, and other tasks), historical data (such as a log of how particular data is commonly accessed by applications), and reporting functionality, to interface with storage administrators and application authors to improve use and configuration of the storage system. Metadata describes where the data is now and any requirements associated with the data. Metadata also describes what stores exist and what their characteristics are.

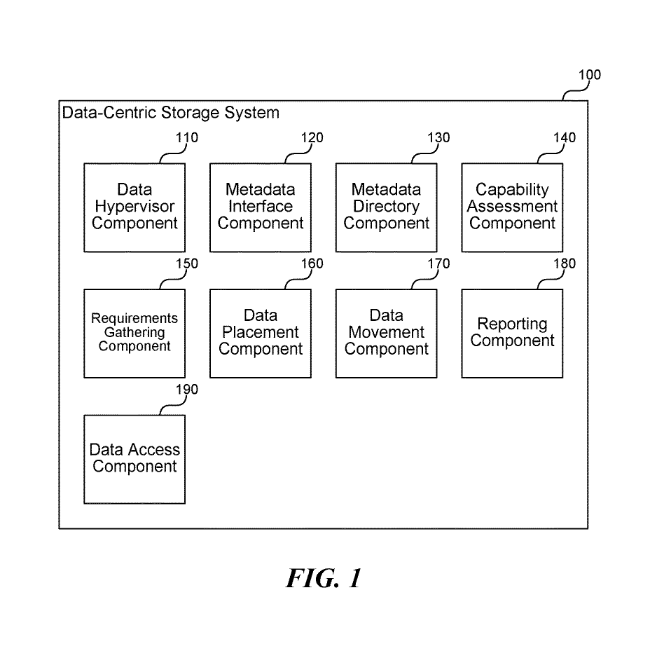

FIG. 1 is a block diagram that illustrates components of the data-centric storage system, in one embodiment. The system 100 includes a data hypervisor component 110, a metadata interface component 120, a metadata directory component 130, a capability assessment component 140, a requirements gathering component 150, a data placement component 160, a data movement component 170, a reporting component 180, and a data access component 190. Each of these components is described in further detail herein.

The data hypervisor component 110 operates from a data access client to request a present location at which identified data can be accessed. The client may request data using a universal naming convention (UNC) name, such as \\server\share, or <server>:/<exported> format. The server portion of the name generally refers to a metadata server that will perform the directory lookup and return to the client an actual address at which to access the data that the client wants. The data hypervisor component 110 is responsible for performing this lookup and using the returned information to initiate access to the actual location of the data. The share or exported portion of the identified data may provide a share name or may simply be a contextual clue to the metadata server about the type of data that the client application is seeking. The metadata server may respond to the client with a new server and/or share location at which to access the data.

The metadata interface component 120 operates at a metadata server to receive client requests to determine the present location at which identified data can be accessed. The metadata server may also provide the client with other information, such as file attributes, hierarchical directory information, or other non-data access requests. In addition, the metadata server may be configured to serve some data access requests, such as those for small files for which two round trips (one to the metadata server and another to a data access server) would be inefficient. The metadata interface component 120 provides the primary interface between clients and one or more metadata servers, and may communicate using a standards-based protocol such as NFS version 4.1 or a proprietary protocol defined by the system 100. The goals of the metadata server are to provide indirection between a client name for data and the data's present location and to offload metadata requests from data access servers to the metadata server. The metadata server may also provide additional information related to accessing data, such as what protocol the data access server uses, a layout of files used by the data access server, and so forth.

The metadata directory component 130 stores a mapping between data items and data stores on which instances of those data items are stored. The granularity at which data items are mapped to data stores may vary by implementation of the system. For some implementations, all of the data on a particular share may be mapped together to the same data storage device, while for other implementations parts of files may be split across data storage devices. This may depend on the file size, application usage, needs for parallel access to various subsets of the data, and so on. The metadata directory component 130 returns the location of at least one instance of a data item upon receiving a client request. In some cases, there may be multiple instances of a data item. For example, read-only data may be copied to various data storage devices so that it can be quickly accessed by many different clients. Data may exist in various snapshots, replicated storage, or may have multiple instances for other reasons.

The capability assessment component 140 inventories the available storage devices, their configuration, and capabilities. The system uses this information to match requirements gathered from applications that store data to map data to one or more storage devices that can most effectively store that data in accordance with the requirements. Capability assessment may include various types of processes. For storage devices that support programmatic enumeration of a device's capabilities and configuration, the system may automatically reach out to such devices and determine their capabilities and configuration. For legacy devices or those that do not support automated enumeration, the system may request that an administrator or other IT personnel input the device's capabilities and configuration into the system via a user interface provided for this purpose. From this information, the system 100 can build a complete map of all of the data storage devices associated with an organization, how they are configured, and what capabilities they have. The system 100 can then use this map to place specific application data on specific storage devices, and possibly to move data from a device where it is presently stored to another device that will allow better data placement within the organization.

The requirements gathering component 150 gathers application needs for data storage at a data feature level. The system 100 collects this information for each of the applications running in a particular organization to create a complete picture of the organization's data storage requirements. In most organizations, there are various classes of applications that have well understood data storage needs. For example, an email server stores a particular type of data that is well understood for each email server application. Other classes of applications and corresponding data are databases, user documents, operating system files, temporary files, and so forth. For gathering application requirements, in some cases it may be sufficient to create client profile and to know how many clients will connect within the organization, and various other profiles for more specialized storage, such as email, sales data management, databases, and so on.

The system 100 can use a variety of automated and user input methods to gather this kind of data. In some cases, IT personnel may input application requirements based on past knowledge of how particular applications use the data storage facilities of the organization. In other cases, the system 100 may include knowledge about particular applications and their data storage needs. The system 100 may also receive automated information describing application data storage requirements, such as that described herein that may be passed in a path or other data between the client and server when data is accessed.

The data placement component 160 uses a figure of merit to match the inventoried available storage devices and the gathered application needs to determine a mapping of data within an organization to the available storage devices. The figure of merit may include a weighted function of various factors, to determine how a particular mapping of data to storage devices will score using criteria such as performance, disaster recoverability, cost (hardware, bandwidth, and other costs), or any other criteria important to an organization or provided by an implementer of the system 100.

For any given set of data, set of data storage devices, and mapping of the data to the data storage devices, the figure of merit can determine a numerical score that assesses that configuration, and can be used to compare that configuration to other possible configurations. The system 100 can use this to iteratively improve the mapping of data to data storage devices as new mappings are determined and evaluated. Upon discovering what appears to be a better mapping, indicated by a higher score output from the figure of merit, the system 100 may also consider factors such as the difficulty of moving data from its current mapping to the new mapping. Thus, data movement may have an inertia-like quality or entropy that may provide feedback into the figure of merit and make a particular data placement, though theoretically more optimal, less optimal to carry out. This and other factors may be used by the system 100 to select a mapping that will ultimately be applied to the system 100 and all of the data stored by it.

The data movement component 170 moves data from a present location to a new location based on a determination by the data placement component 160 that data can be more optimally assigned to the available data storage devices. Data movement may include various sub-processes, such as the copying of data from one location to another, removal of data from the old location (if needed) when the copy is complete, managing copies that occur while clients are still accessing the data, and updating client references to data that may be orphaned by the movement of data. Few large-scale storage systems have the luxury of being taken offline to update to a new data placement, so the data movement component 170 serves an important function in moving data in a manner that reduces downtime for the organization and gets data where it needs to be when clients are ready to access it.

Data movement may occur both on demand and via periodic background processes. In the first case, the system 100 may determine upon receiving a client request to access data that the data can be quickly moved to a more optimal location for the client without unduly delaying the client request. In such cases, the system may perform movement on demand as part of responding to a client data access request. Other events may also lead to an on demand type of data movement, such as the introduction of new data storage hardware to the system, the availability of previously unavailable data storage devices, and configuration changes in the data storage devices. In the second case, periodic movement, the system 100 may run one or more periodic background processes that look for ways to improve data placement. Upon determining a satisfactory and better placement, the system 100 may then initiate movement of some or all of the data to achieve the determined data placement. The system 100 may schedule this work to occur based on information such as historical data access patterns (so that a time of low usage can be selected for the move), planned maintenance windows, time of day/week/holidays, and so forth.

The reporting component 180 generates one or more reports based on a present state of the system 100. The reports may include various reports that are useful for IT personnel to monitor, maintain, and manage the system 100. For example, one report might inform IT personnel where each data object is presently located (i.e., which data storage resources are storing the object), for manual operations and verification of the system 100 operation. Another report might inform IT personnel where new data storage equipment could most effectively be deployed to help the system 100 meet application requested data requirements. Another report might include configuration changes or redeployment of existing data storage resources that would allow for more effective use of existing data storage hardware for meeting the application requested data requirements. The reports are designed to allow IT personnel and others to better manage the system 100 to provide for the most effective storage of data within an organization.

The data access component 190 operates at a data server to provide requested data to an application. After the client has accessed the metadata server to determine where the data the client application wants to access is located for access by that client, the client engages in a more traditional data access request to a data server. This request may use existing, traditional data storage protocols, such as NFS version 3, SMB, AFP, or other data storage protocols. In some cases, the metadata operations may inform the client that the requested data is available via direct attached storage (DAS) or via a local cache, such that the data access component 190 that the client accesses is one providing access through the client's local data storage software stack. This may include using one or more local file system drivers or other software to access DAS via one or more well-known or proprietary protocols. The data access component 190 is ultimately responsible for handling read and write requests of actual data for the client. Different types of storage hardware may include different types of data access components 190, and which data access component 190 the client's read or write request goes through will depend on the outcome of preceding metadata operations.

The computing device on which the data-centric storage system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

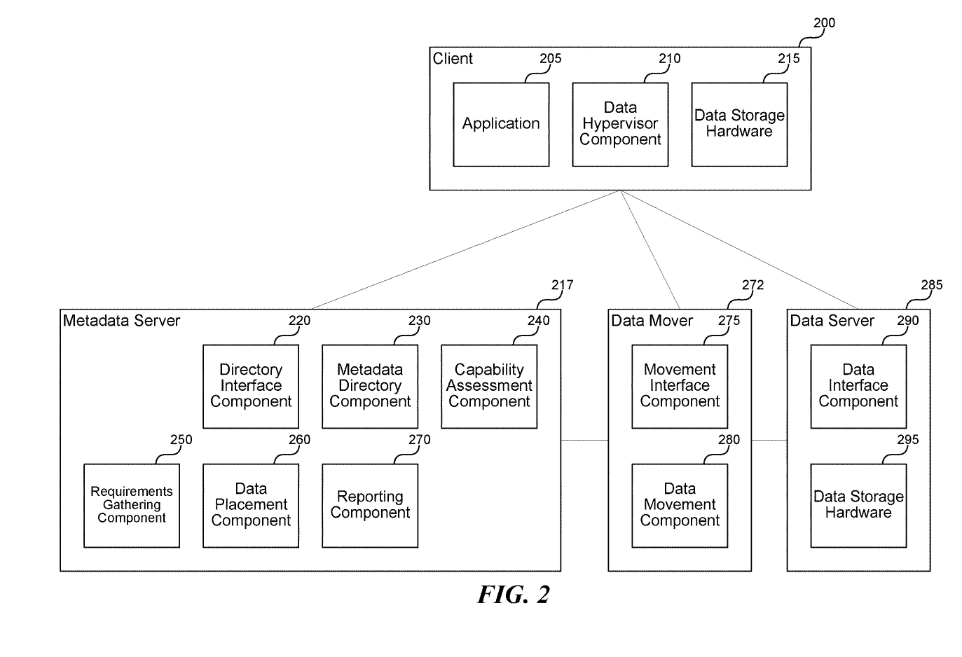

FIG. 2 shows an alternative view of FIG. 1 with major components of the system placed on the machines where they reside, in one embodiment. For example, a client 200, metadata server 217, data mover 272, and data server 285 are shown. On the client 200, an application 205 runs and makes data requests, such as reading, writing, and modifying attributes of one or more files, objects, or other types of data. The application's 205 data requests are received by a data hypervisor component 210 provided by the system. The data hypervisor component 210 may send a request to the metadata server 217 to access metadata associated with a particular data item that the application 205 requests to access. In some cases, the data hypervisor component 210 may maintain a cache of metadata local to the client, such that no request to the metadata server 217 is made. If the data hypervisor component 210 accesses the metadata server 217, it does so via the directory interface component 220, which may then invoke the metadata directory component 230 to find out where data requested by the client 200 is currently located. The client's 200 request may also result in the metadata server 217 invoking the data mover 272 to move data requested by the application 205 to a more suitable location (e.g., on the client 200 itself or to a nearby data server), or the data placement component 260 to determine a location for data the application 205 proposes to write for the first time (e.g., a temporary data file, or application user data).

Once the data hypervisor component 210 knows where the data can be found (in the case or a read or write of an existing file) or should be placed (in the case of a write of a new file), the data hypervisor 210 makes a read or write request, such as to data server 285, through the data interface component 290. The data interface component 290 provides access to data storage hardware 295, where the data resides. The data server 285 may be a NAS or other data storage device, and the data interface component 290 may include an embedded operating system of the NAS or other hardware and/or software for receiving data access requests via one or more well-known or proprietary data access protocols. The client 200 may also include some data storage hardware 215, such as rotating media (e.g., a traditional hard drive), direct attached flash, or other storage devices. In some cases, the data hypervisor component 210 may determine that the data requested by the application 205 is stored locally or should be stored locally on the client, and may act as the data interface component 290 to access the data from the local data storage hardware 215.

The metadata server 217 may also provide a backend interface for IT personnel or other administrators to manage and monitor the system. For example, the reporting component 270 may generate one or more reports, showing information such as how each data storage device is currently being used, where data currently resides, projections describing future needs of an organization for purchasing additional data storage devices or reconfiguring existing data storage devices, compliance with one or more legal requirements, and so forth.

The data movement component 280, although shown on its own data mover 272 machine external to the other three machines described above (client 200, metadata server 217, and data server 285), may exist separately, within any of the other machines, or within multiple of the other machines. For example, in some embodiments, a data movement component 280 may exist within the metadata server 217, and the metadata server 217 may make calls to various data servers 285 to move data from one data server 285 to another. The data movement component 280, wherever it resides, may also update the client 200 as to a new location where data the client is using can be found. The data movement component 280 may also exist on the client 200, and the client 200 may perform some types of data moves. In the illustrated embodiment, a data mover 272 machine is dedicated to running the data movement component 280 such that there is a separate data movement server that directs the movement of data. In some embodiments, the system provides a movement interface component 275 that exposes a programmatic interface through which other components of the system and applications can invoke particular operations and receive information from the data movement component 280. For example, the movement interface may provide operations for requesting a move, subscribing to receive notifications of data movements, and so forth.

Data movement herein is not always a traditional move in which data is copied to a new location and removed from an old location. In some embodiments, the system may determine that data should be copied to multiple locations, and data movement as used herein may refer to the process of copying data from an existing location to one or more new locations, and the data may continue to also reside at the existing location when the operation is complete.

Although shown singly for ease of illustration of the core concepts of the system, those of ordinary skill in the art will appreciate that in a typical organization there may be thousands (or more) of clients and data servers, as well as varying types of data storage hardware managed by the data servers. A given data server may have tens or hundreds (or more) of disks or flash-based storage hardware elements, connected directly, via network, or other connection type. In some embodiments, the system may also operate with multiple metadata servers, whether for redundancy, partitioning of the data space, or other reasons. Thus, FIG. 2 represents a reduced set of the actual system that may be implemented in any particular organization, and represents functional and physical blocks that can be repeated to operate the system at enormous scale to accommodate organizations and data needs of various sizes. On the other hand, the components represented are not a minimal set and may not all be present in all implementations of the system. For example, it is possible to integrate the metadata server into the client, or the data server into the client and/or metadata server.

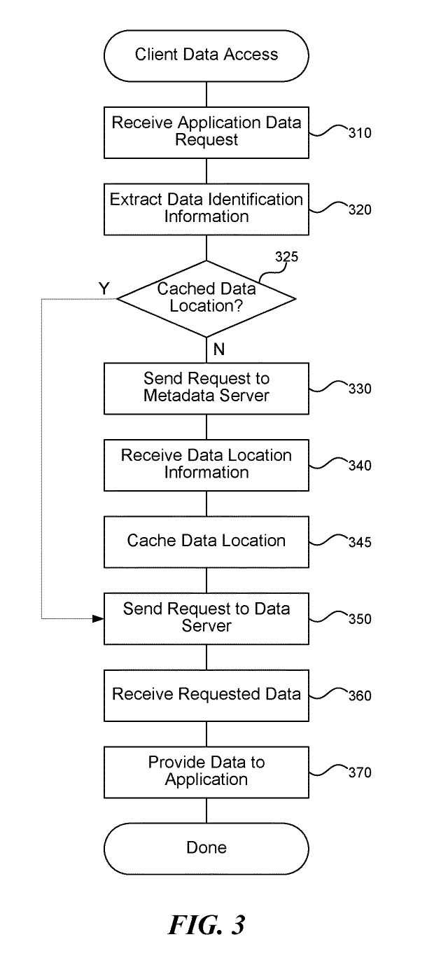

FIG. 3 is a flow diagram that illustrates processing of the data-centric storage system to handle a client application request to access data managed by the system from the perspective of a data hypervisor on the client, in one embodiment.

Beginning in block 310, the system receives a request at the client from an application running on the client to access data expected to be stored on a remote server. The system may include one or more software components that run as drivers or other kernel code in an operating system's data storage stack. When an application makes a data storage request for data expected to be stored on a remote server, the system receives the request through one or more of these components. The request may include one or more parameters or other information, such as a network or UNC path that the application uses to refer to the data that it is requesting. The request may also indicate whether the request is a read, write, or other type of access, and any optional flags specifying how the data is to be accessed (e.g., with or without caching, using a temporary file, read only, and so on).

Continuing in block 320, the system extracts information from the request that identifies which data item the application is requesting. The information may include a network name or IP address, share name, path, file name, and other data identification information. Although in a traditional environment this information refers to the exact server, share, and other information for finding the data, in a data-centric storage system this information merely acts as a handle agreed upon by the application and system for referring to a particular data item, and may have no direct connection to where the data is actually located. The application passes this information to the system, and the system uses this information to determine the actual location of the data.

Continuing in decision block 325, the system determines whether cached data location information is available. If cached data location information is available, then the system jumps to block 350, else the system continues in block 330. If a request has already previously been received to access particular data, then information about the location of that data will likely already be held in a cache. The system may also distribute and receive server updates regarding the location of data, such that when data is moved by the system or for other reasons any clients relying on the location of that data in their caches can invalidate and optionally update their caches.

Continuing in block 330, the system sends a request from the client to the metadata server to determine the location of the identified data item. The system may be configured so that each client knows the address of the metadata server, or the client may determine which metadata server to use from the extracted data identification information. The system forms a request to the metadata server that may include all or part of the address information provided by the application. The system may use a well-known or proprietary protocol to communicate with the metadata server. For example, in some embodiments, the system may use NFS version 4.1 to make metadata requests (e.g., LAYOUTGET).

Continuing in block 340, the system receives data location information at the client describing at least one data server where the requested data item can be accessed. The response may include information such as a server name and path to the data, any time-based limitations on accessing the data (e.g., in the case of a lease), and a handle through which the metadata server can communicate with the client, such as if the access needs to be revoked. In some cases, the system may have changed the location of the data item upon receiving the request, such as by moving the data item to a location that is better (e.g., lower latency, higher bandwidth, closer network proximity) for this particular client to access the item. In other cases, the system may have selected between multiple copies of the data to select one most appropriate for the client to access.

Continuing in block 350, the system sends a request from the client to the actual location of the requested data item. This access may resemble a traditional, normal data request, but differs in that the location for accessing the data was provided by the metadata server. The access may also use regular networking protocols, such as those without knowledge of the metadata server, such as NFS version 3, SMB, AFP, or others. In other cases, the access may use a more direct channel such as that provided by NFS version 4.1 for talking directly to data storage hardware. The request may be a read, write, or other data operation allowed by the data server. In some cases, the metadata server may have instructed the client to find the data at a local data storage device. In such cases, the system may send a request through the local storage software stack to access the data, providing the application with very fast access without the delays of a network.

Continuing in block 360, the system receives the requested data at the client from the data server. In the case of a write, the system may only receive an indication of the success or failure of the write operation. In the case of a read, the system receives the data (or at least a portion of the data) that was requested. If there was an error accessing the data, then the system may receive error information. In some cases, the system may be able to automatically recover from the error by re-attempting the request or by requesting the data from a secondary location. In some embodiments, the original request to the metadata server may have provided one or more alternative locations for accessing the requested data item.

Continuing in block 370, the system provides the data to the application. In general, the application need not be aware of where the data came from, and the data-centric storage system can be inserted into existing organizations without any modification to applications. However, applications and users may notice dramatically increased performance by the superior configuration and usage of the data storage resources provided by the system. After block 370, these steps conclude.

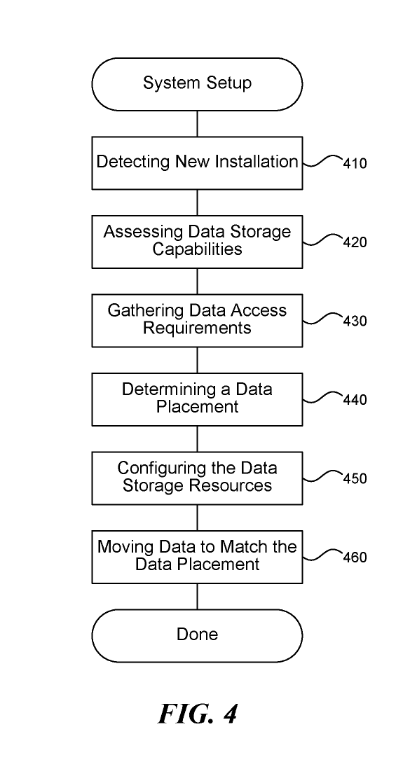

FIG. 4 is a flow diagram that illustrates processing of the data-centric storage system to automatically configure data storage resources when the system is introduced in a new organization, in one embodiment. This process describes processing that the system might perform upon being installed into an organization. In some embodiments, the system may be installed as a software upgrade in an organization. A similar process to that shown may be performed periodically by the system to continue to tune data placement within the organization.

Beginning in block 410, the system detects that the system has been installed in a new organization. The system may typically be deployed in organizations that have many data storage resources and a large legacy of stored data. In some embodiments, the system is designed to continue providing existing access expectations in such an environment while incrementally improving application performance by better configuring and utilizing the available data storage resources. The system does this by moving data to better locations within the organization and providing faster adaptation to changing conditions than is available through non-automated, manual processes.

Continuing in block 420, the system begins automatically assessing the data storage capabilities of the organization. The system may receive input from IT personnel identifying available data storage resources and may programmatically query such resources in cases where the resources provide one or more protocols for doing so. The information may include vendor and model information for various data storage hardware, configuration information that indicates how resources are tiered, what features are active, any association between resources (e.g., X is a mirror of Y), and so forth.

Continuing in block 430, the system also gathers data access requirements of the applications used by the organization. Data requirements may include various parameters that define a successful access condition for an application, such as a maximum latency, minimum bandwidth, expected available space, expected data resiliency (e.g., through redundancy or other techniques), and so on. The system may know these requirements by identifying the application (e.g., databases have certain data access patterns and expectations), or may receive more specific information about an applications needs. This information may come from an IT administrator or may be provided by the application itself. For example, the system may receive a specification in the path or other information provided by an application of one or more requirements of the application.

Continuing in block 440, the system determines a data placement that automatically maps the data of each application to the data storage resources of the organization. The system combines the assessment of the data storage resources with the gathered application requirements to determine a placement of data that will satisfy each application's requirements for accessing data. The system may iteratively improve the placement or may test multiple combinations and permutations to identify placements that not only satisfy each application's requirements, but also provide improved access for each application. In some cases, the IT personnel of the organization may provide priority information that identifies applications whose performance should be prioritized over others. With this information, the system may choose a placement that improves performance for higher priority applications at the expense of lower priority applications.

In some embodiments, the system employs a weighted figure of merit that assigns weightings to each factor affecting an application's data access and computes a score for each data placement that indicates how well that data placement satisfies the overall set of application requirements. The system can use this to numerically evaluate and compare various data placements so that a best available data placement can be selected. The system may also consider in the weighting how difficult achieving the data placement will be. For example, a data placement that involves more movement of data may be passed over for one that can be achieved with less data movement if the movement itself will negatively affect application access to data. In some cases, the system may attempt to achieve a more optimal data placement over time by slowly moving data (e.g., during periods of low activity) but may select a satisfactory initial data placement to start.

Continuing in block 450, the system configures the organization's data storage resources to match the determined data placement. This may include many different types of configuration, such as setting up server names and addresses, configuring redundancy, modifying how network cards are used on a server, modifying network hardware (e.g., switches) to provide improved routing, creating copies of data for distribution to different parts of the network, and so forth.

Continuing in block 460, the system moves data from its current location to match the data placement. Data may be moved for a variety of reasons. For example, low priority data may be occupying expensive and fast data storage resources, while higher priority data may reside on inferior data servers. In some cases, data that is accessed in a particular manner may allow a placement of data that is more optimal. For example, read only data may be copied and distributed to various locations within a network so that any requester can find a nearby copy. Data that is primarily for temporary files can be placed in a location that has less redundancy but application performance may benefit from faster access times (e.g., lower latency) for this data. Such data may even be kept in memory, in some embodiments, where sufficient resources exist. After block 460, these steps conclude.

### Data Movement

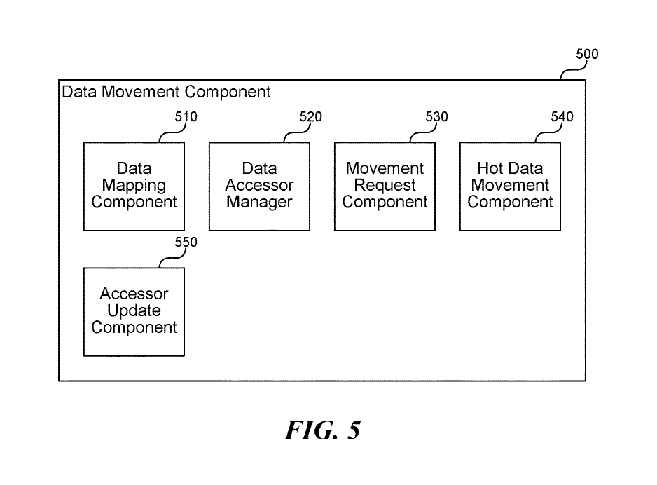

FIG. 5 is a block diagram that illustrates subcomponents of the data-movement component shown in FIG. 1, in one embodiment. The data movement component includes a data mapping component 510, a data accessor manager 520, a movement request component 530, a hot data movement component 540, and an accessor update component 550. Each of these components is described in further detail herein.

The data mapping component 510 stores a mapping between data items and data stores on which instances of those data items are stored. Data items may be stored on one or more data storage devices managed by an organization or others (e.g., a cloud storage provider). In some configurations, data may be stored redundantly on multiple data storage devices for faster access by clients at different locations on the network and/or for data protection (i.e., backup). The data mapping component 510 stores metadata describing the location and other information about each instance of data items managed by the system. The component 510 may use a database or other data organization system to store the data mapping information. For example, a database table may list instances of data items, one or more URLs describing where each data item can be accessed, and other metadata describing each data item. For sufficiently small data items, the data mapping may include the item's data so that requests to access the data can be served directly from the data mapping without additional network requests.

The data accessor manager 520 manages a list of client computing devices currently accessing data and relying on the mapping between data items and data stores. When using the data centric storage system, clients begin accessing data by opening a session with a metadata server that manages the location of data. Data in the data centric storage system can move at any time, and may move between one time a client accesses particular data items and the next time the client access those data items. Data may even move, as described here, while the client is accessing data items. For these reasons, the system manages a list of which client computing devices are currently accessing which data items and which instances of those items if there are multiple instances stored throughout the organization. Thus, clients register with the data accessor manager 520 when a data access session begins, and deregister when the session ends. During the duration of the session, the system will inform registered client computing devices of any changes to the location of data that may affect the devices' access to the data.

The movement request component 530 receives requests to move data that is mapped to a source data store to a target data store. As described herein, requests to move data may arrive at any time and for a variety of reasons. For example, the system may periodically evaluate the distribution of data within an organization and determine that a different distribution will yield better performance or other characteristics to satisfy the organization's data storage goals (e.g., cost, speed of access, and so forth). This determination will result in data movement requests. As another example, the system may determine upon receiving a client request to access data that the data could be more optimally located for the client, and that may lead to a data movement request.

The hot data movement component 540 responds to requests to move data that is currently being accessed by one or more client computing devices and moves the data while the data is still being accessed. Hot data movement refers to the movement of data that is actively being accessed or is soon to be accessed. Hot data movement involves a deep understanding of exactly what data clients are currently accessing, so that those accesses can either continue to be satisfied a the source location while the data moved, or so that coordination with the client can allow the client to stop access at the source location in time before the data moves and restart access at the target location when data movement is complete. Hot data movement may also involve replicating any changes the client continues to make at the source location to the target location, so that the target location is the most up-to-date copy when movement is complete. Hot data movement may rely on a variety of mechanisms built into file systems and data storage protocols. For example, some file systems provide snapshots that allow access of data to continue while movement occurs on a specific point-in-time reference to the data.

The accessor update component 550 informs one or more client computing devices that are accessing data to be moved that the data has changed or will change locations so that the client computing devices can access the data at the new location and so that access to the data is uninterrupted during movement. In some embodiments, the system may leverage protocol-specific mechanisms to inform the client, such as NFS version 4.1's ability to revoke and issue new layouts of data. Such protocols establish a contract with the client that upon receiving particular information from a server the client will access data in a manner that is compatible with moving the data to a new location. For example, the client may be asked to stop accessing one block or data or to avoid accessing another block or data, so that block of data can be moved. The system may move data as a unit or in blocks. When data is moved as a unit, hot data movement may involve pausing all client access of the data until it is moved, or allowing the client to keep accessing the source copy of the data and then later updating the target copy with any changes the client makes. When data is moved in blocks, hot data movement can safely move blocks the client is not actively accessing and care can be taken to move blocks that the client is actively accessing by either pausing or allowing continued access to the old location followed by synchronizing the source and target.

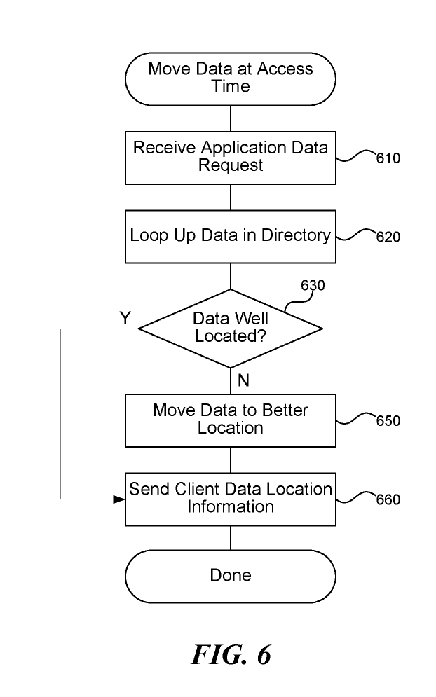

FIG. 6 is a flow diagram that illustrates processing of the data-centric storage system to handle a request to move data when a data access session begins, in one embodiment. Beginning in block 610, the system receives a request from a client to access data. In the data centric storage system, clients begin accessing data by submitting a request to find the data's current location to a metadata server. The metadata server manages information about where data is located and provides that information to the client. The metadata server also manages information about which clients are currently accessing which data, to allow for data to be moved even while the data is being accessed by one or more clients. The received request identifies one or more data items (e.g., by a virtual path, URL, or other data specification), and may also include one or more hints or other information describing how the client plans to use the data items or what types of access requirements the client has (e.g., read only, low latency, secure connection, and so on).

Continuing in block 620, the system looks up the requested data in a data directory to determine the data's current location. The data's current location identifies one or more specific data storage devices where the data can be accessed. The metadata server described herein stores a mapping between data items and data storage devices, and the look up accesses the metadata server to read from the mapping to find the requested data. The mapping includes a data location specification that will allow the client to access the data, such as a URL, path, or other information pointing to a specific data storage device.

Continuing in block 630, the system determines whether the data is well located for the requesting client. Data may be poorly located if it is stored so remotely from the client that accessing the data will have an unacceptable level of latency, if bandwidth between the client and data storage device is too low, if the data storage device is not accessible to the client (e.g., due to firewalls or other configuration issues), if the client's access would interfere with other accesses (e.g., too many clients are already accessing the data), or for other reasons. How well located data is for a particular client may be determined by a scoring function that compares the present location of data with respect to the client to one or more alternate locations available for storing the data. If the scoring function indicates that another location would provide better access to the client, the system may decide to move or copy the data before providing access to the client.

Continuing in decision block 640, if the data needs movement, then the system continues at block 650, else the system continues at block the system continues at block 660. A determination that data is not well located may also include a determination of the cost to move the data (e.g., time needed, storage space consumed at the new location, effect on other accesses of data, and so forth). In some cases, even though data is not well located the system may determine that moving the data is sufficiently costly that the data will not be moved, and is sufficiently well located at the data's present location. If the data needs movement and the cost of movement is acceptable, then block 650 completes the movement to the new location and block 660 provides access to the data at the new location. If the data does not need movement or the movement would be too costly, then block 660 provides access to the data at its present location. In cases where the movement is too costly, the system may flag the data for movement at a later time (e.g., during down time or non-peak hours) that will result in a lower cost.

Continuing in block 650, the system moves the data to a target data server with better access characteristics than the data's current location. The target data server may have faster hardware, be located closer to the client from a networking point of view, have fewer concurrent accessors (i.e., lower load), or be more suitable for other reasons. The data movement may include copying the data and leaving the data at its present location, so that the system serves some clients from one location and other clients from a different location. The data movement may also include moving the data and marking the data as unused at the old location, but waiting until some later time to actually remove the data from the old location.

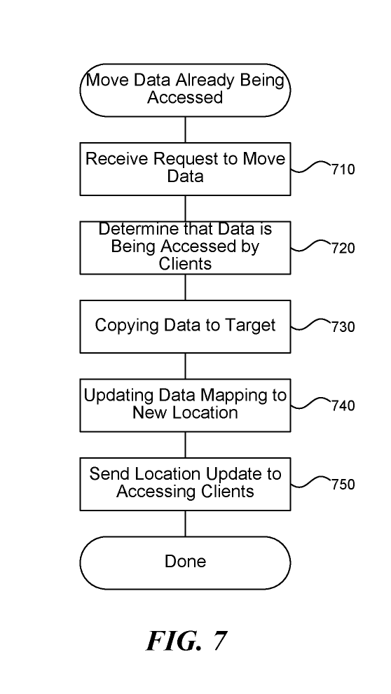

Continuing in block 660, the system sends the requesting client the location of the requested data. The location is either the old location (in the case of data that was not moved) or the new location (in the case of data that was moved). The system provides the client with information describing the location of the data, such as a path or URL, that the client can then access using one or more standard or proprietary data access protocols. The system may also update a list of clients accessing data, so that any further needs for data movement can be done in coordination with clients accessing the data, as described further with reference to FIG. 7. After block 660, these steps conclude.

FIG. 7 is a flow diagram that illustrates processing of the data-centric storage system to handle a request to move data that is already being accessed, in one embodiment. Beginning in block 710, the system receives a request to move data from a source storage device to a target data storage device. Data movement requests may originate from a variety of sources. For example, in some cases actions of an administrator may cause data to be moved from one location to another. For example, the administrator may request to take a server offline for maintenance or may want to replace old hardware with new hardware. In other cases, the system may request that data be moved based on automatically observed characteristics. For example, the system may detect that a data item is routinely accessed from one office of an organization but is stored at another office of the organization, and may elect to move the data to a data server that is local to the office where the data is accessed. In other cases, new information from the client describing how data is used may lead to the data movement request.

Continuing in block 720, the system determines that at least one client is accessing data that at least partially overlaps with the movement request. Many types of data in a data storage environment are continually being accessed. Clients may have documents, audiovisual content, or other data open. Clients of the system may also include servers for other applications. For example, email servers, database servers, and web servers may all be clients of the data managed by the system. These “clients” may have data open related to their server functions, and the system may want to move this data even though it is currently being accessed. Often, it is simply not possible to find a time when data is not being accessed for a long enough period to move the data while no client is accessing the data.

Continuing in block 730, the system copies the data to be moved to the target data storage device. The system may make one or more network requests using one or more well-known or proprietary network protocols for transferring data. Often, even data that is being changed can be copied. The system may leverage available features of the data storage device from which the data is being read, such as snapshots that allow accessing a copy of the data from a particular point in time.

Continuing in block 740, the system updates a data mapping data structure to reflect a new location of the data on the target data storage device. The metadata server described herein includes a mapping that reflects the current location of all data and all copies of that data within the system. Moving data from one location to another entails an update of this mapping information. The system sends an update to the metadata server to indicate the location to which the data was copied.

Continuing in block 750, the system sends an update to the client to inform the client of the new location of the data on the target data storage device. Clients have an interface provided by the system through which they listen for data mapping changes. Clients may cache data mapping information, and may be accessing data affected by the data mapping. Changes in the data mapping can affect proper operation of the client, and thus the system provides for updates to any affected clients when needed to keep any cached data mapping or data being accessed by the client in a consistent state.

Continuing in block 760, the system optionally marks the data for removal at the first data storage device. Once the data has been copied to a new location and clients have been informed to access the data at the new location, it is safe for the system to remove the data from the old location. In some embodiments, the system may listen for and wait for an indication from clients that they have completed all data operations at the old location. This step is optional because it is not always the case that the data is no longer to be stored at the old location. In some cases, data movement operations of the system have the intent of creating a new copy of the same data at multiple locations. This may be desirable where, for example, many types of clients access a particular type of data and need low latency, such that the system places copies of the data close in network proximity to various groups of clients. After block 760, these steps conclude.

From the foregoing, it will be appreciated that specific embodiments of the data-centric storage system have been described herein for purposes of illustration, but that various modifications may be made without deviating from the spirit and scope of the invention. Accordingly, the invention is not limited except as by the appended claims.

### Other Claims

C1. A computer-readable storage medium comprising instructions for controlling a computer system to automatically configure data storage resources when a data-centric storage system is introduced in a new organization, wherein the instructions, upon execution, cause a processor to perform actions comprising:
detecting that the system has been installed in a new organization;
automatically assessing the data storage capabilities of the organization;
automatically gathering data access requirements of one or more applications used by the organization;
determining a data placement that automatically maps the data of each application to the data storage resources of the organization;
configuring the organization's data storage resources to match the determined data placement; and
moving data from its current location to match the data placement.

D1. A computer-implemented method to handle a request to move data when a data access session begins, the method comprising:
receiving 610 a request from a client to access data;
looking up 620 the requested data in a data directory to determine the data's current location;
determining 630 whether the data is well located for the requesting client;
upon determining that the data is not well located for the requesting client, moving 650 the data to a target data server with better access characteristics than the data's current location; and
sending 660 the requesting client the location of the requested data,
wherein the preceding steps are performed by at least one processor.

E1. A computer system for moving data between two or more data storage devices while the data is being accessed by one or more client computing devices, the system comprising:
a processor and memory configured to execute software instructions embodied within the following components;
a data mapping component 510 that stores a mapping between data items and data stores on which instances of those data items are stored;
a data accessor manager 520 that manages a list of client computing devices that are currently accessing data and that are relying on the mapping between data items and data stores;
a movement request component 530 that receives requests to move data that is mapped to a source data store to a target data store;
a hot data movement component 540 that responds to requests to move data that is currently being accessed by one or more client computing devices and moves the data while the data is still being accessed; and
an accessor update component 550 that informs one or more client computing devices that are accessing data to be moved that the data has changed or will change locations so that the client computing devices can access the data at the new location and so that access to the data is uninterrupted during movement.

F1. A computer-readable storage medium comprising instructions for controlling a computer system to move data that is already being accessed, wherein the instructions, upon execution, cause a processor to perform actions comprising:
receiving 710 a request to move data from a source storage device to a target data storage device;
determining 720 that at least one client is accessing data that at least partially overlaps with the movement request;
copying 730 the data to be moved to the target data storage device;
updating 740 a data mapping data structure to reflect a new location of the data on the target data storage device; and
sending 750 an update to the client to inform the client of the new location of the data on the target data storage device.

G1. A computer-implemented method to export direct-attached storage (DAS) for contemporaneous access by both a local client via a local file system and one or more remote clients via a remote file system, the method comprising:
detecting a direct-attached storage device attached to a computer system;
identifying a local file system used to store data on the detected direct-attached storage device;
exposing the detected direct-attached storage device to one or more remote clients via a remote file system while still permitting access by the local client via the identified local file system;
communicating with a metadata server to inform the metadata server of the availability of the detected direct-attached storage device for access by the one or more remote clients; and
managing one or more requests to access the direct-attached storage device to arbitrate conflicts between the local client and any remote clients,
wherein the preceding steps are performed by at least one processor.

G2. The method of claim G1 wherein detecting a direct-attached storage device comprises invoking an operating system device enumeration application-programming interface (API).

G3. The method of claim G1 wherein identifying a local file system comprises invoking an operating system low-level file system application-programming interface.

G4. The method of claim G1 wherein identifying a local file system comprises reading information stored on the direct-attached storage device that identifies the type of file system.

G5. The method of claim G1 wherein exposing the direct-attached storage device comprises registering the direct-attached storage device with an operating system application-programming interface for sharing data storage.

G6. The method of claim G1 wherein exposing the direct-attached storage device comprises making the direct-attached storage device available using Network File System (NFS) as the remote file system.

G7. The method of claim G1 wherein communicating with the metadata server comprises providing information to the metadata server identifying one or more data objects stored on the direct-attached storage device.

G8. The method of claim G1 wherein communicating with the metadata server comprises providing addressing information that remote clients can use to access the direct-attached storage device.

G9. The method of claim G1 wherein managing one or more requests to access the direct-attached storage device comprises providing a synchronization mechanism to ensure consistency of the data stored on the direct-attached storage device during requests by the local client and a remote client.

G10. The method of claim G1 wherein managing one or more requests to access the direct-attached storage device comprises registering a file system filter driver with an operating system to intercept local file system requests from the local client.

G11. The method of claim G1 wherein managing one or more requests to access the direct-attached storage device comprises converting local file system requests from the remote client to remote file system requests so that all requests to access the direct-attached storage device are handled as remote request client requests.

H1. A computer system for providing a multi-mode direct-attached storage device that can be contemporaneously accessed by both a local client via a local file system and one or more remote clients via a remote file system, the system comprising:
a processor and memory configured to execute software instructions embodied within the following components;
a local client interface component that provides an interface to the local client for accessing data stored on the direct-attached storage device via a local file system;
a remote client interface component that provides an interface to the one or more remote clients for accessing data stored on the direct-attached storage device via the remote file system;
a data hypervisor component that manages requests to access data in a data-centric storage environment in which data is identified by an identity other than where the data is stored, such that data stored on the direct-attached storage device may be requested by one or more remote clients;
a metadata server communication component that manages communication between the data hypervisor component and one or more metadata servers to resolve an identity of data to a location where the data can currently be accessed, wherein one possible location where the data may be located is the direct-attached storage device of the local client; and
a request arbitration component that handles any conflicts between contemporaneous access requests to the direct-attached storage devices that originate from the local client and the one or more remote clients.

H2. The system of claim H1 wherein the local client interface component includes an operating system file system software stack for accessing local storage devices of the computer system.

H3. The system of claim H1 wherein the remote client interface component includes an operating system network software stack for receiving remote requests and one or more network protocol handlers for handling received requests and routing the received requests to one or more local storage devices of the computer system.

H4. The system of claim H1 wherein the data hypervisor component responds to requests from the one or more remote clients by accessing data stored on the direct-attached storage device using the local file system and forms a response that provides the data in a format of the remote file system.

H5. The system of claim H1 wherein the data hypervisor component detects requests from the local client that request remote data that is available on the direct-attached storage device and reroutes the requests to the direct-attached storage device.

H6. The system of claim H1 wherein the request arbitration component provides a synchronization mechanism to ensure consistency of the data stored on the direct-attached storage device during requests by the local client and the remote clients.

I1. A computer-readable storage medium comprising instructions for controlling a computer system to re-route requests from a local client addressed to a remote data storage device to a local direct-attached storage device, wherein the instructions, upon execution, cause a processor to perform actions comprising:
receiving a request to access data that specifies addressing information of a remote data storage device;
accessing a metadata server to determine a current location from which to access the requested data;
receiving a response from the metadata server that indicates that the requested data is available locally on the direct-attached storage device;
accessing the requested data via a local file system on the direct-attached storage device; and
responding to the received request with the requested data that was accessed from the direct-attached storage device.

I2. The medium of claim I1 wherein accessing the requested data via the local file system comprises routing the request via an operating system application-programming interface for accessing local storage without sending the request through a network software stack.

I3. The medium of claim I1 wherein accessing the metadata server and receiving the response from the metadata server comprises accessing a cache of data location information previously provided by the metadata server to determine the current location of the requested data.

I4. The medium of claim I1 wherein responding to the received request comprises responding with a latency that is characteristic of a local file access request and lower than a latency that is characteristic of a remote access request.

I/We claim:

1. A computer-implemented method to handle a client application request to access data in a data-centric storage system, the method comprising:
receiving a request at the client from an application running on the client to access data expected to be stored on a remote server;
extracting information from the request that identifies which data item the application is requesting;
sending a request from the client to the metadata server to determine the location of the identified data item;
receiving from the metadata server data location information at the client describing at least one data server where the requested data item can be accessed;
sending a request from the client to a data server storing the requested data item;
receiving the requested data at the client from the data server; and
providing the received data to the application,
wherein the preceding steps are performed by at least one processor.

2. The method of claim 1 wherein receiving the request at the client comprises detecting that an application made a request for remote data in an operating system data storage stack.

3. The method of claim 1 wherein receiving the request at the client comprises receiving one or more parameters including a path that the application uses to refer to the data that it is requesting.

4. The method of claim 1 wherein receiving the request at the client comprises receiving information describing how the application plans to use the requested data.

5. The method of claim 1 wherein extracting information from the request comprises extracting a network name and share that identify which metadata server from which to request the data item's location.

6. The method of claim 1 wherein sending the request to the metadata server comprises forming a request to the metadata server that includes at least some address information provided by the application.

7. The method of claim 1 wherein sending the request to the metadata server comprises forming an NFS version 4.1 LAYOUTGET request.

8. The method of claim 1 wherein receiving data location information comprises receiving a handle through which the metadata server can communicate with the client.

9. The method of claim 1 wherein receiving data location information comprises receiving a location to which the metadata server moved the item upon receiving the request.

10. The method of claim 1 wherein sending the request to the actual location of the data item comprises determining that the data is available at the client and sending the request through a local storage software stack to access the data without delay of a network.

11. The method of claim 1 wherein receiving the requested data comprises receiving an indication of success or failure of a write operation.

12. The method of claim 1 further comprising after extracting information from the request that identifies which data item the application is requesting, accessing a cache to determine whether data location information describing the requested data item is available in the cache, and upon determining that the data location information describing the requested data item is in the cache, bypassing the steps of sending a request to and receiving a response from the metadata server to get the data location information.

13. A computer system for data-centric data storage, the system comprising:
a processor and memory configured to execute software instructions embodied within the following components;
a data hypervisor component that operates from a data access client to request a present location at which identified data can be accessed;
a metadata interface component that operates at a metadata server to receive client requests to determine the present location at which identified data can be accessed;
a metadata directory component that stores a mapping between data items and data stores on which instances of those data items are stored;
a capability assessment component that inventories available storage devices, their configuration, and their capabilities;
a requirements gathering component that gathers application needs for data storage at a data feature level;
a data placement component that uses a figure of merit to match the inventoried available storage devices and the gathered application needs to determine a mapping of data within an organization to the available storage devices;
a data movement component that moves data from a present location to a new location based on a determination by the data placement component that data can be more optimally assigned to the available data storage devices;
a reporting component that generates one or more reports based on a present state of the system; and
a data access component that operates at a data server to provide requested data to an application.

14. The system of claim 13 wherein the data hypervisor component sends a request to a metadata server to determine the present location at which the requested data can be accessed and then sends a request to the present location returned by the metadata server to access the data.

15. The system of claim 13 wherein the metadata interface component negotiates with clients what protocol the data access server will use and a layout of files used by the data access server.

16. The system of claim 13 wherein the metadata directory component includes information describing multiple instances of a data item for at least some data items, and returns to requesting clients an instance of the data item having the best access characteristics for that client.

17. The system of claim 13 wherein the capability assessment component performs programmatic enumeration of a device's capabilities and configuration for at least some storage devices.

18. The system of claim 13 wherein the requirements gathering component receives one or more hints passed by applications to the system during application storage requests.

19. The system of claim 13 wherein the figure of merit used by the data placement component includes a weighted function of various factors to determine how a particular mapping of data to storage devices scores, wherein a higher score indicates a superior data placement.

20. The system of claim 13 further comprising a data movement interface component that exposes a software interface for requesting operations of the data movement component.
